(19) United States
(12) Patent Application Publication
(10) Pub. No.: US 2015/0009363 A1
(43) Pub. Date: Jan. 8, 2015

(54) VIDEO TAGGING METHOD

(71) Applicant: HTC Corporation, Taoyuan City (TW)

(72) Inventors: Kuan-Wei LI, Taoyuan City (TW); Hsien-Wen HUANG, Taoyuan City (TW)

(21) Appl. No.: 13/936,743

(22) Filed: Jul. 8, 2013

(51) Int. Cl. G11B 27/30; H04N 1/21

(52) U.S. Cl. CPC G11B 27/3081; H04N 1/2175
USPC 348/231.3

(57) ABSTRACT

A video tagging method for use in an electronic device is provided. The electronic device has an image capturing device and a processor. The method has the following steps of: recording a video via the image capturing device of the electronic device; and adding a tag to the recorded video automatically by the processor when a specific condition occurs during the recording of the video.

### CROSS REFERENCE TO RELATED APPLICATIONS

### Background of the Invention

1. Field of the Invention

The present invention relates to video tagging, and in particular, relates to an electronic device and method capable of automatically adding tags when recording videos.

2. Description of the Related Art

With advances in technology, it has become popular to record videos by using an electronic device equipped with a camera. In addition, when a user is recording a video, there may be an important moment or scene, wherein after recording, the user may want to review the recorded video to search for the important moment or scene. However, conventional electronic device cannot add tags automatically when recording a video. Therefore, it is very inconvenient for a user to search for important moments or scenes in recorded video by using a conventional electronic device.

### BRIEF SUMMARY OF THE INVENTION

A detailed description is given in the following embodiments with reference to the accompanying drawings.

In an exemplary embodiment, a video tagging method for use in an electronic device is provided. The electronic device comprises an image capture device and a processor. The method comprises the following steps of: recording a video via the image capture device of the electronic device; and adding at least one tag to the recorded video automatically by the processor in response that at least one specific condition occurs during the recording of the video.

In another exemplary embodiment, an electronic device is provided. The electronic device comprises: an image capture device configured to record a video; and a processor configured to add at least one tag to the recorded video automatically in response that at least one specific condition occurs during the recording of the video.

In yet another exemplary embodiment, a video tagging method for use in an electronic device is provided. The electronic device comprises a processor and a display. The method comprises the following steps of: displaying a video on the display of the electronic device; and adding a tag to the video automatically by the processor in response that an image of the video is captured while displaying the video on the display.

In yet another exemplary embodiment, an electronic device is provided. The electronic device comprises: a display; and a processor configured to process a video for displaying on the display, and add a tag to the video automatically in response that an image of the video is captured while displaying the video on the display.

### BRIEF DESCRIPTION OF THE DRAWINGS

The present invention can be more fully understood by reading the subsequent detailed description and examples with references made to the accompanying drawings, wherein:

FIG. 1 is a schematic diagram illustrating an electronic device 100 according to an embodiment of the invention;

FIGS. 2A and 2B are diagrams illustrating the addition of tags to a video by using face detection according to an embodiment of the invention;

FIGS. 3A-3B are diagrams illustrating the linking process between tag, video and captured image according to an embodiment of the invention;

FIG. 4 is a flow chart illustrating a video tagging method according to an embodiment of the invention; and

FIG. 5 is a flow chart illustrating a video tagging method according to another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

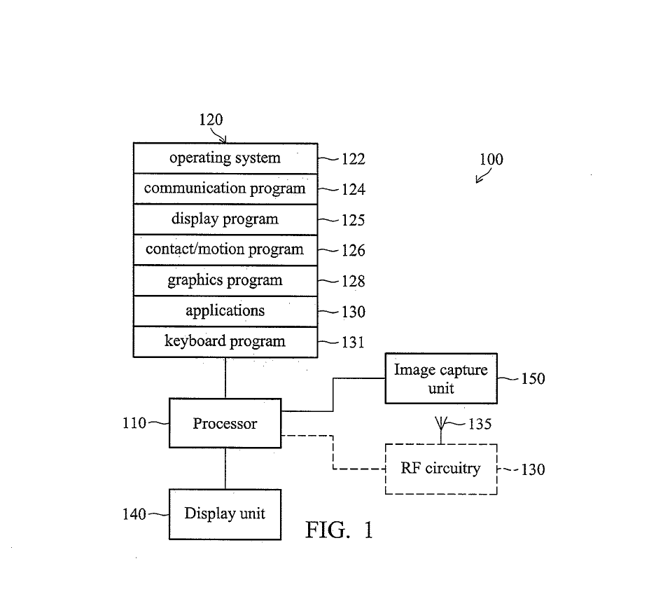

FIG. 1 is a schematic diagram illustrating an electronic device 100 according to an embodiment of the invention. The electronic device 100 may comprise a processor 110, a memory unit 120, a display unit 140, and an image capture unit 150. In an exemplary embodiment, the electronic device 100 may be personal computer or portable device such as mobile phone, tablet, digital camera/camcorder, game console or any suitable device equipped with image recording function. The processor 110 may be data processor, image processor, application processor and/or central processor, and is capable of executing one or more types of computer readable medium stored in the memory unit 120. Specifically, the electronic device 100 may further comprise an RF circuitry 130. In the embodiments, the display unit 140 may be a touch-sensitive screen.

In addition, the RF circuitry 130 may be coupled to one or more antennas 135 and may allow communications with one or more additional devices, computers and/or servers via wireless network. The electronic device 100 may support various communications protocols, such as the code division multiple access (CDMA), Global System for Mobile Communications (GSM), Enhanced Data GSM Environment (EDGE), High-Speed Downlink Packet Access (HSDPA), Wi-Fi (such as IEEE 802.11a/b/g/n), Bluetooth, and Wi-MAX communication protocol, and a protocol for emails, instant messaging (IM), and/or a short message services (SMS), but the invention is not limited thereto.

When the display unit 140 is implemented as a touch-sensitive screen, it may detect contact and any movement or break thereof using any of a plurality of touch sensitivity technologies now known or to be later developed, including, but not limited to, capacitive, resistive, infrared, and surface acoustic wave touch sensitivity technologies, as well as other proximity sensor arrays or other elements for determining one or more points of contact with the touch-sensitive screen. However, the touch-sensitive screen may also display visual output of the electronic device 100. In some other embodiments, the electronic device 100 may include circuitry (not shown in FIG. 1) for supporting a location determining capability, such as that provided by a Global Positioning System (GPS).

The image capture unit 150 may be one or more optical sensors configured to capture images. For example, the image capture unit 150 may be one or more CCD or CMOS sensors, but the invention is not limited thereto.

The memory unit 120 may comprise one or more types of computer readable medium. The memory unit 120 may be high-speed random access memory (e.g. SRAM or DRAM) and/or non-volatile memory, such as flash memory (for example embedded multi media card). The memory unit 120 may store program codes of an operating system 122, such as LINUX, UNIX, OS X, Android, iOS or WINDOWS operating system, or an embedded operating system such as VxWorks. The operating system 122 may executes procedures for handling basic system services and for performing hardware dependent tasks. The memory unit 120 may also store communication programs 124 for executing communication procedures. The communication procedures may be used for communicating with one or more additional devices, one or more computers and/or one or more servers. The memory unit 120 may comprise display programs 125, contact/motion programs 126 to determine one or more points of contact and/or their movement, and graphics processing programs 128. The graphics processing programs 128 may support widgets, i.e. modules or applications, with embedded graphics. The widgets may be implemented using JavaScript, HTML, Adobe Flash, or other suitable computer program languages and technologies.

The memory unit 120 may also comprise one or more application programs 130. For example, application programs stored in the memory unit 120 may be telephone applications, email applications, text messaging or instant messaging applications, memo pad applications, address books or contact lists, calendars, picture taking and management applications, and music playback and management applications. The application programs 130 may comprise a web browser (not shown in FIG. 1) for rendering pages written in the Hypertext Markup Language (HTML), Wireless Markup Language (WML), or other languages suitable for composing web pages or other online content. The memory unit 120 may further comprise keyboard input programs (or a set of instructions) 131. The keyboard input programs 131 operates one or more soft keyboards.

It should be noted that each of the above identified programs and applications correspond to a set of instructions for performing one or more functions described above. These programs (i.e., sets of instructions) need not be implemented as separate software programs, procedures or modules. The various programs and sub-programs may be rearranged and/or combined. Various functions of the electronic device 100 may be implemented in software and/or in hardware, including one or more signal processing and/or application specific integrated circuits.

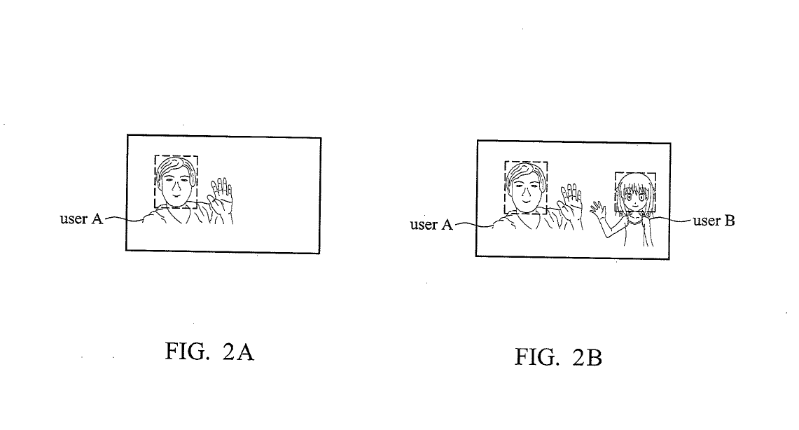

FIGS. 2A and 2B are diagrams illustrating the addition of tags to a video by using face detection according to an embodiment of the invention. In an embodiment, the processor 110 may obtain a number of human faces in the video during recording by using known face detection techniques. When the processor 110 detects that the number of human faces is increased or decreased, it may indicate that there are one or more people entering or leaving the scene, which may have some importance. Thus, the processor 110 may automatically add a tag to the video. For example, the electronic device 100 is recording a video of a scene 200 and there is only one human face (e.g. user A) detected by the processor 110 in the scene 200, as illustrated in FIG. 2A. The processor 110 may consistently detect the number of human faces in the video (e.g. at the scene 200). When a user B enters the scene 200, the electronic device 100 may capture the images of both the user A and the user B, as illustrated in FIG. 2B. In response to the increase of the number of human faces within the scene 200, the processor 110 automatically adds a tag to a frame in which the face of user B first appears within the video.

Alternatively, the processor 110 may also detect some specific objects (e.g. a cat, a dog) appearing in the video currently recording. When a specific object is detected in the video at another moment, the processor 110 may also add a tag to the frame in which the specific object first appears within video correspondingly. Once tags for various scenes are built for the video, it is easy for a user to select a desired tag freely while viewing the video.

Note that the electronic device 100 is capable to take photos while recording a video in other embodiments of the invention. During the recording of the video, the processor 110 may capture a photo corresponding to an image frame currently recording in response to receiving an image capture input, add a tag to the corresponding image frame of the video, and then associate the photo and the corresponding tag of the video. When the user views the photo on the electronic device 100, a visual icon or indicator of the corresponding tag of the video associated with the photo will be displayed on the display unit 140 for selection by the user if desired. If the corresponding tag is selected, the video associated with the photo will be displayed from the moment the photo was taken, i.e. from the corresponding image frame of the tag. It should be noted that the user may use the electronic device 100 to take multiple photos while recording a video, and thus tags corresponding to the multiple photos may be added to multiple image frames of the video. Each of the image frame recorded with a tag represents different time point within the video. Conversely, when the user views the recorded video on the electronic device 100, visual icon or indicator of the one or more tags associated with the video may be displayed on the display unit 140, so that the user may select a desired tag to view the photo corresponding to the desired tag.

In yet another embodiment, the processor 110 may detect the sound volume of the surroundings during recording of the video. When a sound change occurs, it may be of some importance. For example, a relatively large sound volume may indicate laughter or singing etc. The processor 110 may further add a tag to the frame first detected with sound peak within the video automatically upon detection of sound condition change. In embodiments of the invention, the processor 110 may determine various sound conditions for adding tags, such as sound volume exceeding a predetermined threshold, sound volume below another predetermined threshold, occurrence of a different sound frequency, occurrence of a constant sound over a period of time, etc. In embodiments of the invention, the processor 110 may provide a user interface on the display unit 140 for user to configure desired conditions of adding tags to the video. Once tags corresponding to various events are built for the recorded video, it is easy for a user to select a desired tag freely while viewing the recorded video.

It should be noted that the aforementioned embodiments illustrating various ways for automatically adding tags while recording a video can be integrated. That is, the processor 110 may detect faces, photo capturing operations, and sound conditions simultaneously while recording a video, and then add corresponding tags to the recorded video.

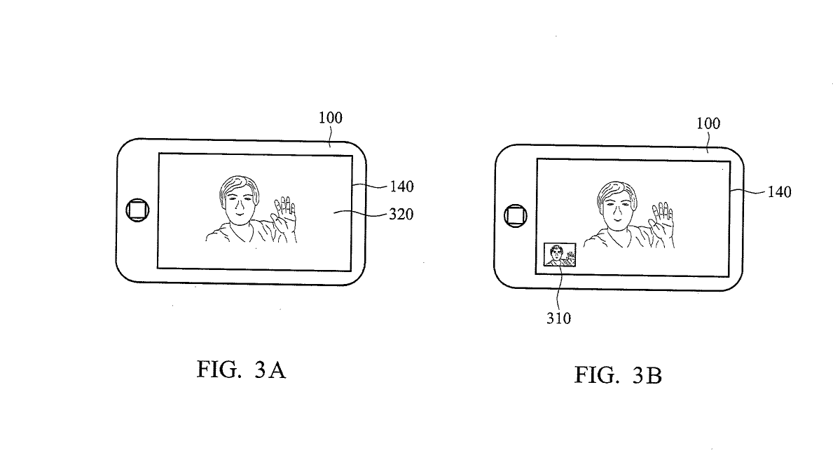

FIG. 3A-3B are diagrams illustrating the linking process between tag, video and captured photo according to an embodiment of the invention. In still another embodiment, the electronic device 100 can be used to play a video and the user may capture a photo 320 (e.g. a screenshot) of the video by a specific image capture input, such as pressing software/hardware buttons of the electronic device 100, as illustrated in FIG. 3A. Specifically, the video can be displayed in a full screen mode on the display 140, and accordingly the photo 320 is retrieved from the video in response to the trigger of an image capture input, such as a tap on the display unit 140. Consequently, the processor 110 may add a tag to the video automatically upon capturing the photo 320, and associate the photo 320 (e.g. a screenshot) and the tag together in the gallery application (e.g. an album) of the electronic device 100. Accordingly, when the user is viewing the photo 320 in the gallery on the electronic device 100, the processor 110 may illustrate a thumbnail 310 (as graphics or visual indicator) of the video corresponding to the photo 320 on the display unit 140, as illustrated in FIG. 3B. The user may tap the thumbnail 310 on the display unit 140 to view the video corresponding to the photo 320, which corresponds to the tag associated with the photo 320, on the electronic device 100.

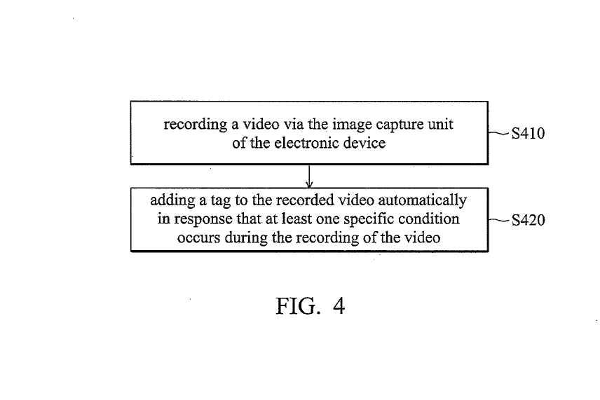

FIG. 4 is a flow chart illustrating a video tagging method according to an embodiment of the invention. In step S410, a video is recorded via the image capture unit 150 of the electronic device 100. In step S420, the processor 110 of the electronic device 100 adds a tag to the video automatically in response to at least one specific condition occurs during the recording of the video. It should be noted that the aforementioned specific condition may be the processor 110 detecting the change of the number of human faces or objects in the video, a specific object in the video, a sound condition change, or whether a photo is taken during the recording of the video. It is also noted that the aforementioned ways can be integrated to add corresponding tags to the video simultaneously.

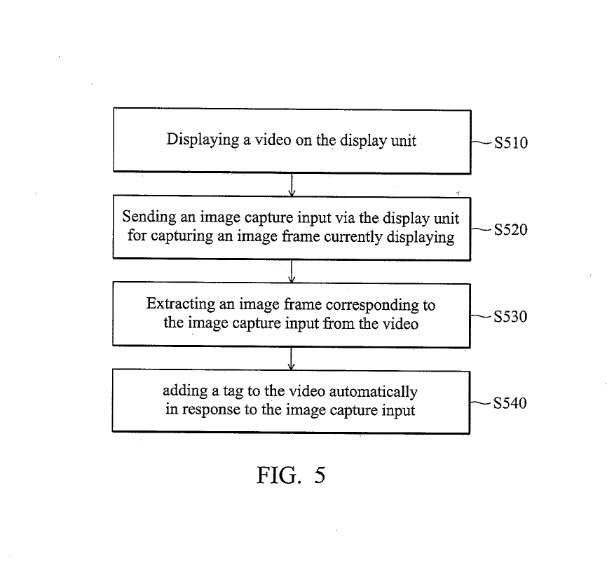

FIG. 5 is a flow chart illustrating a video tagging method according to another embodiment of the invention. In step S510, a video is displayed on the display unit 140 of the electronic device 100. In step S520, user may send an image capture input via the display unit 140 for capturing an image frame currently displaying. In step S530, the processor 110 extracts an image frame corresponding to the image capture input from the video. In step S540, the processor 110 adds a tag to the video automatically in response to the image capture input. The tag may be added to the image frame at which the image capture input is received. It should be noted that the video can be displayed in a full screen mode or in a partial area of the display unit 140, and the captured image may comprise the displayed region of the video. Upon receiving the image capture input, the processor 110 may add a corresponding tag to the image frame currently displaying within the video. In another embodiment of the invention, the processor 110 may extract the image frame displayed upon the capture input is received and save the extracted image frame as a separated photo. The separated photo is associated with the tag within the video.

The methods, or certain aspects or portions thereof, may take the form of a program code embodied in tangible media, such as floppy diskettes, CD-ROMs, hard drives, or any other machine-readable (e.g., computer-readable) storage medium, or computer program products without limitation in external shape or form thereof, wherein, when the program code is loaded into and executed by a machine, such as a computer, the machine thereby becomes an apparatus for practicing the methods. The methods may also be embodied in the form of a program code transmitted over some transmission medium, such as an electrical wire or a cable, or through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A video tagging method for use in an electronic device, wherein the electronic device comprises an image capture unit and a processor, the video tagging method comprising:
recording a video by the image capture device of the electronic device; and
adding at least one tag to the video automatically by the processor in response to occurrence of at least a specific condition during the recording of the video.

2. The video tagging method as claimed in claim 1, wherein the adding of the tag further comprises adding the tag to an image frame corresponding to the occurrence of the specific condition within the video.

3. The video tagging method as claimed in claim 1, wherein the at least one specific condition is one of the following: change of a number of human faces within a scene in the video, appearance of a specific object within the video, a sound condition change and an image capture input.

4. The video tagging method as claimed in claim 2, further comprising:
detecting a number of human faces appearing in the video, wherein the specific condition is met in response to the number of human faces changes during the recording of the video; and
adding the tag to an image frame in which the number of human faces first changes.

5. The video tagging method as claimed in claim 2, further comprising:
detecting whether a specific object appears in the video; and
adding the tag to an image frame in which the specific object first appears;
wherein the specific condition is met in response to the specific object is detected in the video.

6. The video tagging method as claimed in claim 2, wherein the specific condition is met in response to an image capture input is received during the recording of the video, and the method further comprises:
capturing a photo corresponding to an image frame currently recording upon receiving the image capture input;
adding the tag to the image frame; and
associating the tag to the photo.

7. The video tagging method as claimed in claim 2, wherein the specific condition is met in response to a sound change is detected in the video, and the sound change comprises at least one of the following: a sound volume exceeding a first predetermined threshold, the sound volume below a second predetermined threshold, occurrence of a different sound frequency, occurrence of a constant sound over a period of time.

8. The video tagging method as claimed in claim 1, further comprising:
providing a user interface on a display unit of the electronic device for a user to configure the specific condition.

9. The video tagging method as claimed in claim 1, further comprising:
playing the video on the electronic device after completion of the recording;
receiving an image capture input during the playing of the video;
extracting an image frame corresponding to the image capture input by the processor as a separated photo by the processor;
adding a second tag to the image frame within the video by the processor; and
associating the second tag and the separated photo by the processor.

10. An electronic device, comprising:
an image capture unit, configured to record a video; and
a processor, configured to add at least one tag to the video automatically in response to occurrence of at least a specific condition during the recording of the video.

11. The electronic device as claimed in claim 10, wherein the processor is further configured to add the tag to an image frame corresponding to the occurrence of the specific condition within the video.

12. The electronic device as claimed in claim 10, wherein the specific condition is one of the following: change of a number of human faces within a scene in the video, appearance of a specific object within the video, a sound condition change and an image capture input.

13. The electronic device as claimed in claim 12, wherein the processor is further configured to detect a number of human faces in the video, and the specific condition is met in response to the number of human faces changes during the recording of the video.

14. The electronic device as claimed in claim 12, wherein the processor is further configured to detect whether a specific object appears in the video, and the specific condition is met in response to the specific object is detected in the video.

15. The electronic device as claimed in claim 12, wherein the specific condition is met in response to receiving an image capture input during the recording of the video, and the processor is further configured to extract an image frame within the video as a separated photo in response to the image capture input and associate the tag to the separated photo.

16. The electronic device as claimed in claim 12, wherein the specific condition is met in response to a sound condition change, and the sound condition change comprises at least one of the following: sound volume exceeding a first predetermined threshold, sound volume below a second predetermined threshold, occurrence of a different sound frequency, occurrence of a constant sound over a period of time.

17. The electronic device as claimed in claim 12, further comprising:
a display unit, configured to display the video and receive at least one image capture input during recording of the video, and configured to provide a user interface for a user to configure the specific condition.

18. A video tagging method for use in an electronic device, wherein the electronic device comprises a processor and a display unit, the video tagging method comprising:
displaying a video on the display unit of the electronic device; and
receiving an image capture input during the displaying of the video by the display unit;
capturing a photo corresponding to an image frame currently displayed in response to the image capture input; and
adding a tag associated with the photo to the video automatically by the processor.

19. The video tagging method as claimed in claim 11, further comprising:
providing a graphics icon corresponding to the tag during the displaying of the video.

20. The video tagging method as claimed in claim 18, wherein the adding of the tag further comprises adding the tag to the image frame corresponding to the photo within the video.
